(19) United States
(12) Patent Application Publication
(10) Pub. No.: US 2024/0240863 A1
(43) Pub. Date: Jul. 18, 2024

(54) Installation for the thermal drying of wood by CO2 sequestration

(71) Applicant: WAYS SAS, SAMOIS-SUR-SEINE (FR)

(72) Inventors: Yann RAOULT, Samois Sur Seine (FR); Guillaume CARMASSI, SAMOIS SUR SEINE (FR)

(21) Appl. No.: 18/404,698

(22) Filed: Jan. 4, 2024

(30) Foreign Application Priority Data
Jan. 5, 2023 (FR) 2300130
Jan. 5, 2023 (FR) 2300136

(51) Int. Cl. F26B 21/14; F26B 9/06; F26B 21/10; F26B 21/12

(52) U.S. Cl. CPC F26B 21/14; F26B 9/06; F26B 21/10; F26B 21/12; F26B 2210/16

(57) ABSTRACT

The invention relates to an installation for the thermal drying of wood by CO₂ sequestration, having at least one CO₂ atmosphere drying module comprising: a drying chamber (1), means of supply of CO₂ (3), means of heating (2), means of gas circulation (4), means of recycling (600) of the CO₂, metrological means (5), means of supply of CO₂ (3), and a computerised control system (6), characterised in that the means of gas circulation (4) comprise a flow reversal module configured to allow the circulation of CO₂ in a first direction forming a closed-loop circulation duct for the CO₂ gas mixture, and in a second direction of circulation opposite to the first direction, capable of rendering uniform the thermal distribution in said drying chamber (1).

The present invention relates to an installation for the thermal drying of wood by CO₂ sequestration, in particular, but not exclusively, for the industrial drying of timber, industrial wood, fuel wood, logs and similar lignocellulosic material.

The terms “timber, industrial wood” are used here to refer to wood intended for use in the secondary wood processing sectors, in particular for industry, construction, joinery, or for exterior and interior fittings for urban, industrial, collective and domestic use.

Wood is any lignocellulosic material or similar compound capable of sequestering CO₂.

The term CO₂.sequestration means in this case any substitution, trapping of CO₂, chemical reaction between CO₂/wood polymers/water or complexation or stable accumulation of CO₂. or carbonation of wood or of water contained in wood with compounds such as wood to be dried or similar receiving material.

A system as taught by document WO2020127026, using wood drying cells under a CO₂. atmosphere, is known.

The disadvantage of these systems is that the temperature of the gas mixture circulating in the drying chamber cannot be maintained uniformly, resulting in poor uniformity of drying of the wood.

A gas mixture is defined as the combination of gaseous and liquid compounds circulating in the drying installation at a time t.

A drying system as taught by document GB 849613 A is also known, having a vertical flow inverter to ensure uniform drying.

The disadvantage of this system is that it does not make it possible to limit the presence of water in the liquid state in said drying chamber, or to guarantee that the temperature of the drying environment is uniform during use at all points in the drying chamber.

Although various solutions exist for drying timber, roundwood and/or logs, the known solutions are only rarely suitable for industrial applications and have a low energy balance. The known solutions are indeed generally used on a small scale, to consume a minimum amount of energy while obtaining wood with a low water content, and do not make it possible to achieve drying with a neutral or negative carbon balance.

Another disadvantage of the existing solutions is the length of time it takes to operate a drying installation, which often takes several days or even several weeks, a factor that limits its effective use for industrial applications.

Furthermore, current installations all too often struggle to achieve the objective of raising the temperature so as to be homogeneous right to the core of a mass of wood, while achieving precise humidity of the dried wood and guaranteeing the integrity of the wood's internal structure during and after drying.

Another disadvantage of the current drying processes and installations is that only a very small amount of CO₂ can be sequestered in the wood to be dried.

The aim of the present invention is to overcome these problems.

The invention relates to an installation for the thermal drying of wood by CO₂ sequestration, having at least one CO₂ atmosphere drying module comprising: a drying chamber comprising at least one hollow cylindrical or virtually cylindrical drying tube of a diameter and length suitable for drying wood of selected dimensions,
means of supply of CO₂ for injecting gaseous CO₂ into the drying chamber, —means of heating for reheating the circulating CO₂,
means of gas circulation for forcing the circulation of the CO₂ from one end of the drying chamber to the other end, and
means of heating for reheating the circulating CO₂; —means of gas circulation for forcing the circulation of CO₂ from one end of the drying chamber to the other in a closed circuit in the direction of the length of the chamber, with injection and extraction positioned at the ends of the drying chamber, and for renewing the atmosphere inside the drying chamber;
means of recycling of the CO₂ configured to allow the separation of water vapour and gaseous CO₂ present in the atmosphere extracted from the chamber during drying;
metrological means for measuring the variations in the physical measurements of the drying module during heating;
means of supply of CO₂; and
a computerised control system for controlling the means of supply of CO₂, the means of circulation, the means of reheating and the means of recycling, according to programmes, setpoint values and drying times appropriate to the quality of the dried wood required, and means of processing for measuring, comparing and readjusting the operating parameters to the setpoint values in the event of deviations.

According to a general definition of the invention, the means of gas circulation of the CO₂ atmosphere drying module furthermore comprise a flow reversal module configured to allow the circulation of CO₂ in a first direction of circulation in the drying chamber between an inlet duct connecting the means of heating to the drying chamber, configured to control the injection of the CO₂ gas mixture into the drying chamber and an outlet duct connecting an outlet end of the drying chamber to the said means of heating, forming a closed-loop circulation duct for the CO₂ gas mixture, and in a second direction of circulation opposite to the first direction, capable of rendering uniform the thermal distribution in said drying chamber.

In practice, the inlet duct comprises a solenoid valve configured to control the injection of the CO₂ gas mixture into the drying chamber, as well as means of gas circulation comprising at least one fan capable of operating bilaterally in two directions of circulation of the gas mixture, i.e. towards the drying chamber, and from the drying chamber, and in that the outlet duct comprises a solenoid valve configured to control the discharge of the CO₂ gas mixture into the drying chamber, as well as means of gas circulation comprising at least one fan capable of operating bilaterally in two directions of circulation of the gas mixture, i.e. towards the drying chamber, and from the drying chamber, the gas circulation means being configured to operate simultaneously in the same direction of circulation.

Alternatively, the inlet duct comprises a solenoid valve configured to control the injection of the CO₂ gas mixture into the drying chamber, said inlet duct comprising at least two ducts connected to the drying chamber, each duct comprising at least one fan, each fan being configured to operate in one direction of circulation, i.e. at least one fan towards the drying chamber and one fan from the drying chamber in the inlet duct, and in that the outlet duct comprises at least two ducts connected to the drying chamber, each duct comprising at least one fan being configured to operate in one direction of circulation, i.e. at least one fan towards the drying chamber and one fan from the drying chamber to the means of heating.

In practice, the outlet duct also comprises metrological means configured to measure parameters belonging to the group formed by the flow rate of the injected circulating CO₂ gas mixture, the temperature of the injected circulating CO₂ gas mixture and the humidity of the circulating gas mixture.

In addition, the means of recycling of the CO₂ comprise a heat exchanger-type system configured to cool the circulating gas mixture in order to cause condensation of the water in said mixture and enable extraction of said condensed water, and configured to reheat the cooled gas mixture following extraction of the water to a temperature differential of 50° C. with the temperature of the circulating gas mixture, for re-injection into the drying chamber.

According to one embodiment of the invention, the means of recycling of the CO₂ are of the heat exchanger type comprising at least one cold battery, configured to gradually extract water from the gas mixture, each cold battery being capable of extracting a chosen percentage of water from said gas mixture.

According to a second embodiment, the heat exchanger of the means of recycling of the CO₂ is only active during the drying phase, and when the measured humidity of the circulating gas mixture is between a maximum threshold value and a minimum threshold value.

By way of a non-limiting example, the means of supply of CO₂ belong to the group formed by a system for injecting CO₂ from CO₂ in a pressurised cylinder, a CO₂ supply discharged from a methanisation plant, a CO₂ supply of the industrial chimney type, and an installation for wood drying by attached CO₂ sequestration, or a combination thereof.

In practice, the computerised control system is equipped with an application programming interface (API) configured to:
Acquire metrological data and parameters of the wood to be dried by measuring the metrological means;
Activate the means of supply of CO₂ configured to saturate the drying chamber with CO₂;
Verify that the CO₂ saturation in the circulating gas mixture is sufficient to initiate a drying cycle by checking the means of measurement of CO₂/CH4 in the discharge duct;
Activate the means of heating to adjust the humidity of the wood by heating when a sufficient measured CO₂ saturation is achieved.
If the humidity of the wood exceeds 30%, heat with a temperature limit according to a first setpoint temperature T1, according to a selected temperature gradient G1 in order to extract the free water from the wood to be dried and activate the means of circulation;
If the humidity of the wood is less than 30%, heat with a temperature limit according to a first setpoint temperature T2, according to a selected temperature gradient G2 in order to extract the bound water from the wood to be dried and activate the means of circulation;
stabilise the temperature of the CO₂ circulating in the drying chamber in a first phase when a humidity of less than or equal to 30% is measured, activate the recycling means and subsequently increase the temperature of the CO₂ circulating in the drying chamber in a second phase until the measured moisture content of the wood reaches a chosen intermediate target value Hi, the means of heating being activated so that reheating is carried out with a limit temperature defined by a second setpoint temperature T2 of 120° C. according to a selected temperature gradient G2, and as a function of the specific drying profile of the wood to be dried enabling the bound water to be extracted from the wood to be dried;
Deactivate the means of recycling and vary the activity of the means of heating to reduce the temperature of the heating chamber in a first phase, down to a third stabilisation setpoint temperature T3 chosen according to a temperature gradient G3, when the average humidity of the wood measured via the means for measurement of the humidity of the wood reaches the chosen intermediate target value Hi, unless one of the measured humidity values of the wood is greater than Hi+A %, A being a selected value, said setpoint temperature T3 being maintained for a selected period of time until the measured humidity value of the wood greater than Hi+A % is stable and within a range of values less than Hi+A %;
Deactivate the means of heating, in order to reduce the temperature of the heating chamber in a second phase, when the measured average humidity of the wood reaches the final target humidity value Hc.

Advantageously, the drying installation according to the invention also makes it possible to obtain a shrinkage of the wood of less than 5%, whereas the standard shrinkage with conventional drying means is 10 to 15%.

The Applicant has also observed that the drying installation according to the invention makes it possible to obtain dried wood with less reabsorption of humidity, a reduction in the colour of the dried wood, as well as the limitation/absence of the appearance of cracks during drying.

In addition, the drying installation according to the invention makes it possible to obtain uniform drying and a shrinkage of less than 5%, while limiting the presence of water in the liquid state in the drying chamber

Other advantages and characteristics of the invention will appear on examination of the description and drawings in which:

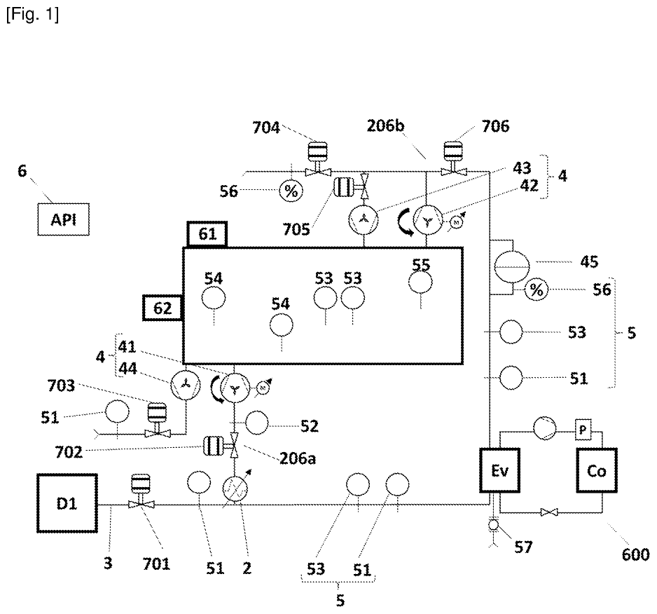

FIG. 1 schematically represents the drying installation according to the invention;

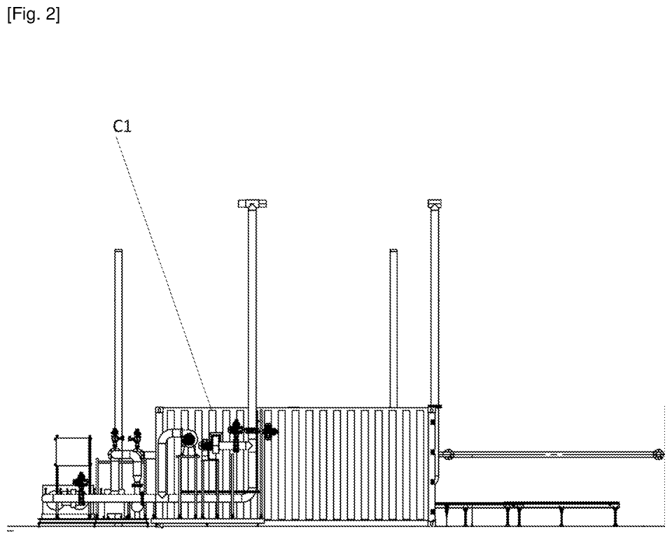

FIG. 2 represents a front view of the drying installation according to the invention;

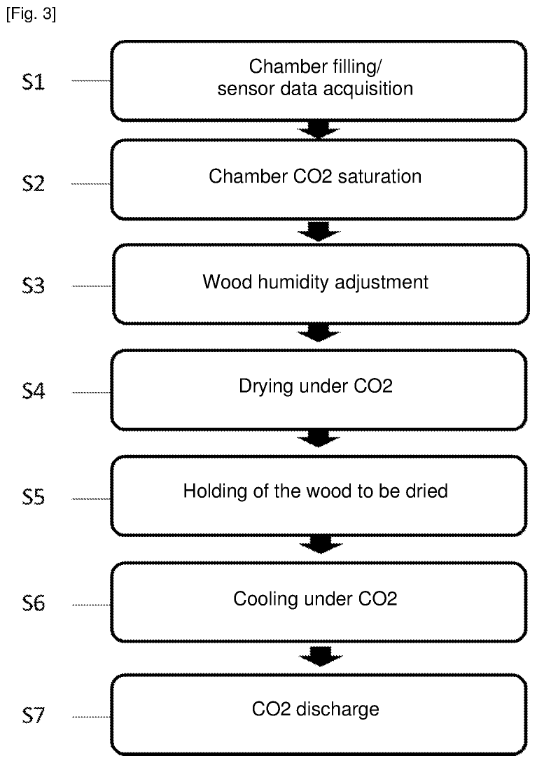

FIG. 3 schematically represents the stages of the process implemented by the drying installation according to the invention;

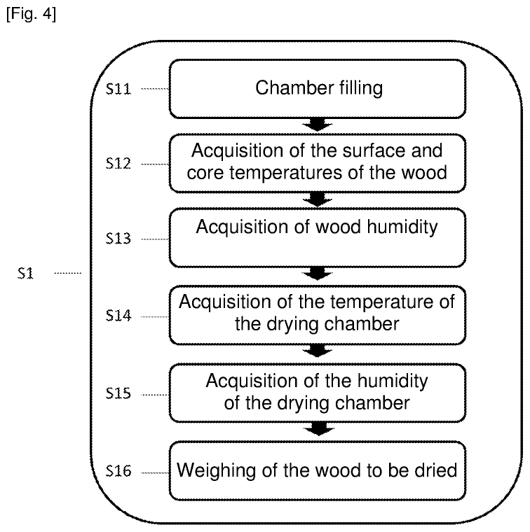

FIG. 4 schematically represents the sub-stages of the chamber filling/sensor data acquisition stage of the process implemented by the drying installation according to the invention;

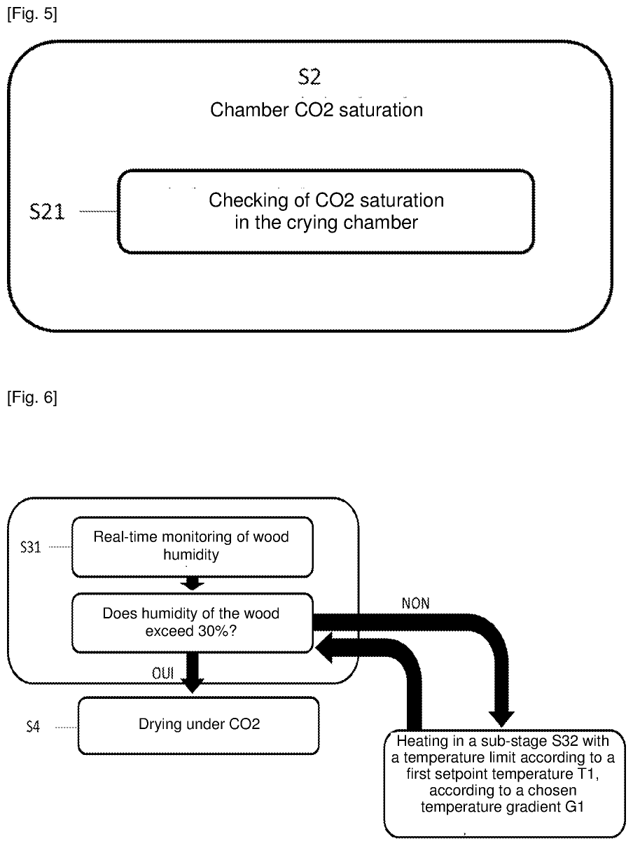

FIG. 5 shows schematically the sub-stages of the chamber CO₂ saturation stage of the process implemented by the drying installation in accordance with the invention;

FIG. 6 schematically represents the sub-stages of the wood humidity adjustment stage of the process implemented by the drying installation according to the invention;

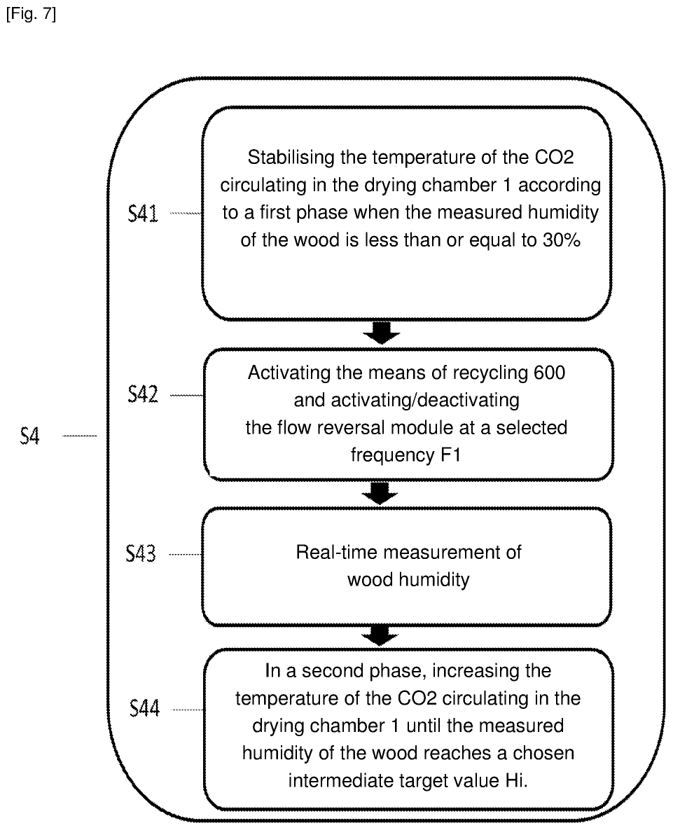

FIG. 7 schematically represents the sub-stages of the CO₂ drying stage of the process implemented by the drying installation according to the invention;

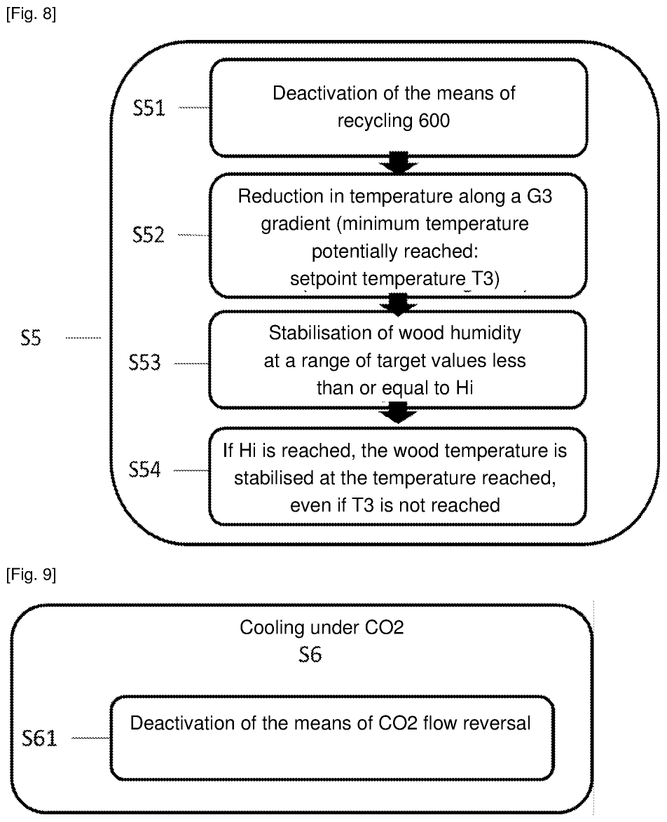

FIG. 8 schematically represents the sub-stages of the holding stage of the wood to be dried of the process implemented by the drying installation according to the invention; and

FIG. 9 schematically represents the sub-stages of the CO₂ cooling stage of the process implemented by the drying installation according to the invention.

With reference to FIGS. 1 and 2, the drying installation according to the invention comprises at least one drying module C1, each drying module C1 having several functional groupings including a heating chamber 1 comprising at least one drying tube into which the wood to be dried is introduced, means of heating 2, means of supply of CO₂ 3, means of gas circulation 4 enabling renewal of the atmosphere inside the drying chamber 1, several metrology measurement units forming metrological means 5, and finally a computerised control system 6 equipped with an application programming interface (API).

The drying module C1 has a drying chamber 1 consisting of one or more hollow cylindrical drying tubes for introducing the wood to be dried.

The drying chamber 1 is connected to the means of heating 2 by an inlet duct 206a, and has an outlet duct 206b configured to discharge a CO₂ or CO₂/H₂O gas mixture from said drying chamber 1 depending on the state of progress of the drying.

In practice, the inlet duct 206a is arranged at a first end of the drying chamber 1 and the outlet duct 206b at a second end of the drying chamber 1 so as to allow longitudinal circulation of the CO₂ gas mixture relative to the wood to be dried.

By way of a non-limiting example, the drying chamber 1 comprises a closed, heat-insulated tube with internal atmospheric recirculation.

According to a particular embodiment of the invention, the drying chamber 1 comprises a minimum volume of 10 m³ that is saturable with CO₂.

According to one embodiment, the drying chamber 1 according to the invention comprises metrological means 5 configured to measure parameters belonging to the group formed by humidity of the wood to be dried, humidity in the drying chamber 1, temperature of the wood to be dried, temperature in the drying chamber 1 and pressure in the drying chamber 1.

According to one embodiment, the drying chamber 1 according to the invention comprises at least one sensor for measuring the temperature and humidity in the drying chamber 53.

By way of a non-limiting example, the drying chamber 1 comprises two sensors for measuring the temperature and humidity in the drying chamber 53.

According to one embodiment, the drying chamber 1 according to the invention comprises at least one sensor for measuring the humidity of the wood to be dried 54.

By way of a non-limiting example, the drying chamber 1 comprises two sensors for measuring the humidity of the wood to be dried 54.

In practice, the drying chamber 1 also comprises a control box 61 configured to receive and process the data recorded by the sensors measuring the humidity of the wood to be dried 54.

According to one embodiment, the drying chamber 1 according to the invention also comprises a pressure measurement sensor 55 in said drying chamber 1, enabling emergency discharge of part of the atmosphere contained in the drying chamber 1 in the event of critical pressure therein.

In practice, each metrological measurement includes a setpoint value or a group of setpoint values to be respected, specific to each species or application of the wood to be dried.

In practice, the critical pressure may be 1.5 bar.

The drying chamber 1 according to the invention also comprises door closure sensors 62, configured to detect the closure status of the doors for inserting the wood to be dried.

By way of a non-limiting example, the drying chamber 1 is 5.5 m in length with a circulation diameter of 2.4 metres, cylindrical or virtually cylindrical in shape and enclosed in a maritime container insulated with wood wool panels 60 mm thick. This box is connected from one end to the other by a heat-insulated insulated pipe, a heating system 2 and four centrifugal circulation fans capable of withstanding temperatures of up to 250° C.

The drying module C1 furthermore comprises operating means configured to operate and control the drying in each drying module C1 and corresponding to any means arranged outside the drying chamber 1 enabling operation thereof.

The drying module C1 comprises means of supply of CO₂ 3 configured to control the injection of the CO₂ gas mixture from at least one CO₂ source.

The means of supply of CO₂ 3 comprise a pipe connected on the one hand to the CO₂ source, and on the other hand to the means of heating 2, said pipe being equipped with a solenoid valve 701 for controlling the injection of CO₂ into the drying module C1.

In practice, a command is sent to the solenoid valve 701, triggering its opening in order to supply the drying installation with CO₂.

In practice, the means of supply of CO₂ 3 also comprise metrological means 5 configured to measure parameters belonging to the group formed by the flow rate of the injected circulating CO₂ gas mixture and the temperature of the injected circulating CO₂ gas mixture.

According to one embodiment, the means of supply of CO₂ 3 comprise at least one sensor for measuring the temperature and flow rate 51 of the circulating gas mixture.

The drying installation furthermore comprises means of supply of CO₂ 3, comprising a CO₂ source belonging to the group formed by biogenic CO₂ and non-biogenic CO₂.

According to another alternative embodiment, the means of supply of CO₂ 3 comprise at least one so-called “direct” CO₂ supply module, and a so-called “recycled” CO₂ supply module, connected to the drying module C1 and configured to allow the injection/stopping of the injection of CO₂ into the drying module C1.

Direct CO₂ denotes CO₂ originating from a source of CO₂ in the form of gas that has not been purified on exiting the off-gas or industrial chimney and the gas mixture of which containing CO₂ is used directly by the C1 drying module without any change in the phase of the CO₂.

Recycled CO₂ refers to CO₂ originating from a CO₂ supply derived from a CO₂ source, such as CO₂ packaged in cylinders and liquefied.

In practice, the means of supply of CO₂ 3 consist of at least one system for injection of CO₂ from CO₂ originating from a distribution system towards the means of heating 2.

The drying module C1 furthermore comprises means of heating 2, connected to the means of supply of CO₂ 3 on the one hand, and to the drying chamber 1 on the other hand via an inlet duct 206a.

In practice, the means of heating 2 are of the immersion heater type and more particularly of the “in-line electric heater” type.

By way of example, the immersion heater has a power rating of 90 KW, and comprises an inlet through which the gases to be heated enter, an open cylindrical or virtually cylindrical steel duct into which an immersion heater is inserted, and finally a second outlet opening for the gases thus heated. The immersion heater furthermore comprises a thermostat for regulating the temperature of the immersion heater.

According to a first embodiment, the means of drying 1 consist of a plurality of drying modules C1, connected to means of heating 2 common to several drying modules C1.

According to an alternative embodiment, the means of drying 1 consist of a plurality of drying modules C1, each connected to individual means of heating 2.

The inlet duct 206a comprises a solenoid valve 702 configured to control the injection of the CO₂ gas mixture into the drying chamber 1, in addition to means of gas circulation 4.

In practice, the means of gas circulation 4 of the inlet duct 206a comprise at least one fan 41 capable of operating bilaterally in two directions of circulation of the gas mixture, i.e. towards the drying chamber 1, and from the drying chamber 1.

Alternatively, the inlet duct 206a comprises at least two ducts connected to the drying chamber 1, each duct comprising at least one fan 41. These fans 41 are each configured to operate in one direction of circulation, i.e. at least one fan towards the drying chamber 1 and one fan from the drying chamber into the inlet duct 206a.

The means of heating 2 are also connected to an outlet duct 206b connecting an outlet end of the drying chamber 1 to said means of heating 2, and forming a closed loop circulation duct for the CO₂ gas mixture.

The outlet duct 206b comprises a solenoid valve 706 configured to control the discharge of the CO₂ gas mixture into the drying chamber 1, in addition to means of gas circulation 4.

In practice, the means of gas circulation 4 of the outlet duct 206b comprise at least one fan 42 capable of operating bilaterally in two directions of circulation of the gas mixture, i.e. towards the drying chamber 1, and from the drying chamber 1.

Alternatively, the outlet duct 206b comprises at least two ducts connected to the drying chamber 1, each duct comprising at least one fan 42. These fans 42 are each configured to operate in one direction of circulation, i.e. at least one fan towards the drying chamber 1 and one fan from the drying chamber towards the means of heating 2.

By way of a non-limiting example, the means of circulation 4 of the fan type 41, 42, are of the medium-pressure, single-suction centrifugal fan type with a sheet steel casing and impeller, said fan comprising an impeller with forward-inclined blades made of galvanised sheet steel, the fan 51 being capable of withstanding a maximum temperature of the air or CO₂ to be transported of −20° C. to 250° C.

The means of circulation 4 of the inlet duct 206a in combination with the means of circulation 4 of the outlet duct 206b form a flow reversal module capable of allowing the circulation of the CO₂ gas mixture from the means of heating 2 to the drying chamber 1 in a first direction of operation and from the drying chamber 1 to the means of heating 2 in a second direction of operation, and thus force the circulation of the CO₂ gas mixture in a closed circuit, through the drying chamber 1 in two directions of circulation.

Advantageously, the alternative circulation of the CO₂ in the inlet duct 206a and outlet duct 206b in two directions of circulation enables the CO₂ to circulate longitudinally in the direction of the length of the drying chamber 1 with injection and extraction positioned advantageously at the ends of the drying chamber 1, thereby maintaining a uniform temperature of the gas mixture in the drying chamber 1 and thus enabling drying of the wood and uniform treatment of the CO₂ in the wood.

The Applicant has observed that the use of the flow reversal module and more specifically the circulation of CO₂ longitudinally in the drying chamber 1 in an alternative manner makes it possible to limit the presence of water in the liquid state within the drying chamber 1, and thus make optional the use of an angled drying chamber and a swan-neck type removal system to remove the water in liquid form that may accumulate at the bottom of the drying chamber 1.

In addition, uniform drying of this kind makes it possible to achieve tangential shrinkage of less than 5% and radial shrinkage of less than 4%, in contrast to an average standard shrinkage of around 10% to 15% with conventional drying processes. The invention also drastically reduces warping of the lumber and, in particular, prevents the knots in the wood from distorting during drying. This reduced warping of the wood during drying can represent savings in material of up to 20%, depending on the application.

In practice, the fans 41, 42 of the inlet duct 206a and the outlet duct 206b are coupled to frequency inverters that advantageously enable the speed of rotation to be reduced as a function of the species of wood to be dried, and therefore the flow rate of the circulating gas mixture as a function of the humidity level of the wood and the temperature of the circulating gas mixture, and thus optimise the uniformity of drying.

The outlet duct 206b furthermore comprises a bypass for sampling the circulating gas mixture 45 and incorporating means of measurement of the CO₂/CH₄ 56, configured to measure the proportion of CO₂ in relation to the total volume of circulating gas and the proportion of CH₄ circulating during the CO₂ drying phase of the drying module C1, and thus to check CO₂ saturation throughout the circuit of the drying module C1.

Advantageously, monitoring the CO₂/CH₄ in the gas mixture during drying makes it possible to record changes in the concentration of the various compounds in the circulating gas mixture and thus to adjust the operation of the drying module 1, but also to ensure the safety of the drying module C1 in the event of a drastic increase in the quantity of CH₄.

In practice, if the quantity of CH₄ in the circulating gas mixture during drying exceeds 3.5%, the C1 drying module is immediately drained.

The outlet duct 206b also comprises metrological means 5 configured to measure parameters belonging to the group formed by the flow rate of the injected circulating CO₂ gas mixture, the temperature of the injected circulating CO₂ gas mixture and the humidity of the circulating gas mixture.

According to one embodiment, the outlet duct 206b comprises at least one sensor for measuring the temperature and flow rate 51 of the circulating gas mixture.

By way of a non-limiting example, the outlet duct 206b comprises at least one sensor for measuring the temperature and the circulating flow rate 51 arranged upstream and a sensor for measuring the temperature and the circulating flow rate 51 arranged downstream from the means of recycling 600 of the CO₂.

According to one embodiment, the outlet duct 206b comprises at least one sensor for measuring the temperature and the humidity 53.

By way of a non-limiting example, the outlet duct 206b comprises at least one sensor for measuring the temperature and the humidity 53, arranged upstream and a sensor for measuring the temperature and the humidity 53, arranged downstream from the means of recycling 600 of the CO₂.

In practice, the outlet duct 206b comprises at least one sensor for measuring the temperature and humidity 53, arranged upstream and one sensor for measuring the temperature and humidity 53, arranged downstream from the means of recycling 600 of the CO₂, and at least one sensor for measuring the temperature and the circulating flow rate 51, arranged upstream and one sensor for measuring the temperature and the circulating flow rate 51, arranged downstream from the means of recycling 600 of the CO₂.

Advantageously, such an arrangement allows monitoring of the composition of the circulating gas mixture, as well as the activity of the means of recycling 600 of the CO₂ and their adjustment.

The drying module C1 according to the invention also comprises means of recycling 600 of the CO₂ arranged at the outlet duct 206b for separating the water vapour and the gaseous CO₂ present in the atmosphere extracted from the chamber 1 during drying, in order to be able to eliminate the water while recovering the CO₂ for storage or direct reuse in the installation.

By way of a non-limiting example, condensation-type means of recycling 600 are used, reducing the temperature of the binary water vapour/CO₂ gas mixture extracted from the drying chamber 1 to a selected temperature, allowing condensation of the water in the gas mixture, which is subsequently recovered by gravity in liquid form and disposed of. In practice, the means of recycling 600 allow the drying of the internal atmosphere extracted from the drying chamber 1 via thermal condensation of the water vapour by cooling, on at least one heat exchanger equipped with at least one cold battery; several cold batteries configured in series can advantageously be used to increase the dehumidification capacity of each drying module C1. The system therefore allows the dehydrated atmosphere to be re-injected into the drying chamber 1.

In practice, each heat exchanger comprises at least one evaporator EV and at least one condenser CO.

According to one embodiment of the invention, the heat exchanger of the means of recycling 600 is only active when the humidity of the circulating gas mixture is between two threshold values.

In practice, the heat exchanger of the means of recycling 600 of the CO₂ is only active during the drying phase, and when the measured humidity of the circulating gas mixture is between a maximum threshold value and a minimum threshold value.

For instance, the humidity threshold values in the drying chamber 1 are 20% for the minimum threshold and 100% for the maximum threshold.

According to one embodiment of the invention, the means of recycling 600 comprise a system of the heat exchanger type comprising at least two cold batteries, configured in series to gradually extract water from the gas mixture, each cold battery being capable of extracting a chosen percentage of water from said gas mixture.

Advantageously, a series of cold batteries can be used to limit the humidity in the drying chamber 1, thereby limiting the duration of the drying cycle, solving the performance problem of a conventional heat exchanger when the humidity is higher than the critical operating value, and thereby reducing the duration of each cycle, causing each drying module C1 to operate for a shorter period of time and limiting the associated energy expenditure.

According to one embodiment, the means of recycling 600 furthermore comprise a discharge outlet configured to discharge condensed water or condensate, said discharge outlet incorporating a water flow meter 57.

The water flow meter 57 is configured to record the discharge flow rate of the water to be discharged, and thus makes it possible to correlate the quantity of water discharged to the difference between the initial and final humidity level of the wood for a drying cycle.

In practice, the heat exchanger of the means of recycling 600 can also be used to reheat the dehydrated gas mixture before reinjection into said installation.

According to a particular embodiment of the invention, the heat exchanger is configured to reheat the cooled gas mixture after extraction of the water to a temperature differential of 50° C. with the temperature of the circulating gas mixture, for re-injection into the drying chamber 1.

By way of example, maintaining the humidity in the drying chamber 1 below a chosen value makes it possible to shorten the drying cycle, for which the means of circulation 213a, 213b of the CO₂ in the drying module(s) C1 may account for 5 to 20% of the energy expenditure.

Advantageously, the means of recycling 600 make it possible to control the humidity of the gas mixture and thus to control the quality of the drying of the wood, thereby optimising the drying process and the quality of the material obtained, while limiting energy expenditure and maintaining a low temperature deviation between the CO₂ exiting the means of heating 2 and the CO₂ originating from the recirculation module 206c.

In practice, the CO₂ gas recovered by the means of recycling 600 can be stored in means of storage, or re-injected directly into the drying chamber 1.

According to a particular embodiment of the invention, the drying chamber 1 comprises at least one discharge circuit, which is followed by a so-called “breathing” duct comprising at least one solenoid valve 704, 705 to allow breathing of the drying chamber 1, permitting air from outside the installation to be injected into the drying chamber 1 and the gas mixture contained in said drying chamber 1 to be discharged.

The discharge circuit furthermore comprises fan-type 43 means of circulation 4, as well as means of measurement of the CO₂/CH₄ 56, configured to measure the proportion of CO₂ relative to the total volume of circulating gas and the proportion of CH₄ circulating during the phase of filling the drying module C1 with CO₂, and thus to check the CO₂ saturation throughout the circuit of the drying module C1 during said filling, and configured to allow drainage of the drying chamber 1.

According to one embodiment, the drying module C1 according to the invention also comprises an additional discharge outlet connected to the drying chamber 1 and comprising at least one fan 44 followed by an outlet solenoid valve 703 as well as a sensor for measuring the circulating gas flow rate and temperature 51, and configured to allow the flow rate and temperature of the gas mixture to be measured when the drying chamber 1 is drained.

By way of a non-limiting example, the fan-type 43, 44 means of circulation 4 of the additional discharge outlet and of the discharge circuit are of the medium-pressure, single-suction centrifugal fan type with sheet steel casing and impeller, said fan comprising an impeller with forward-inclined blades made of galvanised sheet steel, the fan 51 being capable of withstanding a maximum temperature of the air or CO₂ to be transported of −20° C. to 250° C.

The drying module C1 also incorporates a computerised control system 6 comprising an application programming interface (API). The application programming interface can be used, on the one hand, to manage the sending of instructions to each of the installation components and, on the other hand, to integrate the data received by the various metrological means 5, in order to adjust the instructions sent to the installation components.

In practice, the drying module C1 furthermore comprises an energy consumption meter.

The computerised control system 6 is configured to control the means of supply 3, of circulation 4, of heating 2 and of recycling 600 according to programmes, setpoint values and drying times appropriate to the required quality of the dried wood, and processing means for measuring, comparing and readjusting the operating parameters to the setpoint values in case of deviation.

The computerised control system 6 also allows monitoring, measurement and recording of all the metrological values measured in a table (including energy consumption), as well as emergency procedures (shutdown without resumption of drying or with resumption of drying).

In practice, the computerised control system 6 is equipped with an application programming interface (API) capable of implementing a drying process.

In practice, during drying, if the pressure measurement sensor 55 in the drying module C1 detects an internal pressure of less than 15% of atmospheric pressure for a specified period, the computerised control system 6 opens the solenoid valve 701 of the means of supply of CO₂ 3 so as to inject fresh CO₂. The drying module C1 furthermore comprises at least one environment sensor arranged outside said module and capable of recording the temperature and humidity in the environment surrounding said drying module.

According to one embodiment of the invention, the computerised control system 6 is also configured to enable control of the dehumidification of the CO₂ by activating the means of recycling 600 as a function of a minimum (20%) and maximum (100%) value for the humidity of the atmosphere in the drying chamber 1. This phase is continuous, regardless of the initial humidity of the wood.

With reference to FIGS. 3 to 12, the installation for the thermal drying of wood by CO₂ sequestration thus described with reference to FIGS. 1 and 2 implements a process for drying and sequestering CO₂ in the wood that comprises a succession of stages.

According to a stage of acquisition of the metrological data and parameters of the wood to be dried S1, metrological data and parameters of the wood to be dried are acquired by the measurement of the metrological means 5.

In addition, the various parametric data are measured in order to calibrate the setpoint values to be applied.

In practice, the stage of acquisition of the metrological data and parameters of the wood to be dried S1 comprises the following sub-stages:
Filling the drying chamber with the object to be dried S11;
Measuring the surface and core temperature of the wood S12;
Measuring the humidity of the wood to be dried S13;
Measuring the temperature of the drying chamber S14;
Measuring the humidity of the drying chamber S15; and
Measuring the weight of the wood to be dried S16.

For instance, the wood to be dried is inserted into the drying chamber 1 and the drying chamber is subsequently sealed hermetically.

In practice, the difference between the surface and core temperatures of the wood must be less than or equal to 20° C. throughout the entire drying process.

In addition, the sub-stage of measuring the weight of the wood to be dried S16 enables the loss of mass involved in implementing the drying process to be calculated and the quantity of water extracted to thus be quantified, taking into account the quantity of CO₂ sequestered.

By way of a non-limiting example, the maximum quantity of CO₂ sequestered is 250 kg/m³ of wood.

According to a stage of CO₂ saturation S2 of the drying chamber 1, the means of supply of CO₂ 3 are activated.

In practice, the CO₂ saturation stage S2 comprises a sub-stage of verification S21 of the CO₂ saturation in the circulating gas mixture, in order to ensure that said minimum CO₂ saturation to initiate a drying cycle is achieved.

In practice, verification of the CO₂ saturation S21 is implemented by measurement via the means of measurement of CO₂/CH₄ 56 in the discharge duct of the drying module C1.

According to one embodiment, when the ratio R=P[CO₂] input/P[CO₂] output is between 0.8 and 1.2, the minimum CO₂ saturation is achieved.

According to an alternative embodiment, verification of the CO₂ saturation S21 is implemented by measurement of the percentage CO₂ in the circulating gas mixture.

According to a wood humidity adjustment stage S3, the means of heating 2 are activated to adjust the humidity of the wood to be dried so that the measured humidity of the wood is less than or equal to 30%. The means of heating 2 are activated when the minimum CO₂ saturation is achieved.

The wood humidity adjustment stage S3 comprises the following sub-stages:
Measuring the humidity of the wood in real time S31.

In practice, if the measured humidity of the wood exceeds 30%, heating according to a sub-stage S32 with a temperature limit according to a first setpoint temperature T1, according to a selected temperature gradient G1 in order to extract the free water from the wood to be dried and activating the means of gas circulation 4.

By way of a non-limiting example, the first setpoint temperature T1 is between 50° C. and 60° C.

By way of a non-limiting example, the chosen temperature gradient G1 is 2° C./hour.

If the humidity of the wood is less than or equal to 30%, a drying stage S4 is implemented directly, and involves increasing the temperature of the circulating gas mixture with a temperature limit according to a second setpoint temperature T2, and according to a chosen temperature gradient G2, in order to extract the bound water from the wood to be dried and activate the means of gas circulation 4.

The drying stage S4 of the drying process comprises sub-stages involving:
stabilising S41 the temperature of the CO₂ circulating in the drying chamber 1 in a first phase when the measured humidity of the wood is less than or equal to 30%;
activating S42 the means of recycling 600 and activating/deactivating the flow reversal module at a selected frequency F1, configured to reverse the direction of the CO₂ flow in the drying chamber 1;
Measuring the humidity of the wood in real time S43; and
in a second phase, increasing S44 the temperature of the CO₂ circulating in the drying chamber 1 until the measured humidity of the wood reaches a chosen intermediate target value Hi.

In practice, the means of heating 2 are activated so that heating is carried out with a limit temperature defined by a second setpoint temperature T2 of 120° C. according to a selected temperature gradient G2, and as a function of the specific drying profile of the wood to be dried enabling the bound water to be extracted from the wood to be dried.

Setpoint temperatures T1 and T2 are temperature limits that each drying module C1 may not exceed during these phases.

In practice, the setpoint temperature T2 is less than or equal to 120° C.

By way of a non-limiting example, the chosen temperature gradient G2 is between 1 and 3° C./hour.

In practice, the intermediate target value Hi chosen for the measured humidity of the wood is equal to the desired final target humidity Hc+1.5 to 2.5%.

In addition, achieving the chosen intermediate value Hi is made possible by controlling the means of recycling 600 via a high hysteresis (hys-h) and a low hysteresis (hys-b). These two parameters make it possible to activate the means of recycling 600 in corroboration with the humidity measured in the drying chamber 1 in order to avoid activating/deactivating the means of recycling 600 or of supply of CO₂ in the event of a humidity measurement fluctuating between a value above and below the chosen intermediate value Hi.

In practice, the temperature gradient G2 is chosen as a function of the specific drying profile of the wood to be dried, enabling the bound water to be extracted from the wood to be dried, as well as dynamically, so as to be adjusted as the chosen intermediate target value Hi for wood humidity is approached.

By way of a non-limiting example, the pressure measured in the drying chamber is between 0.8 and 1 bar.

In a holding stage of the wood to be dried S5, the temperature in the drying chamber 1 is stabilised.

The holding stage of the wood to be dried S5 is implemented by deactivating S51 the means of recycling 600, and by adjusting the activity of the means of heating 2 to reduce the temperature S52 of the heating chamber 1 in a first phase S51, down to a third stabilisation setpoint temperature T3 chosen according to a temperature gradient G3, when the average humidity of the wood measured via the means for measuring the humidity 54 of the wood reaches the chosen intermediate target value Hi, the humidity is stabilised S53.

In practice, if one of the measured humidity values of the wood is greater than Hi+A %, said setpoint temperature T3 is maintained for a selected period of time until the measured humidity value of the wood greater than Hi+A % initially is stable and within a range of values of less than Hi %.

By way of a non-limiting example, the third setpoint temperature T3 is between 60 and 100° C.

By way of a non-limiting example, the range of target humidity values is between a final target humidity value Hc and a final target humidity value Hi, i.e. the target wood humidity value Hc+A %.

In practice, the value A is between 1 and 2.5%.

In practice, when the measured humidity is stable and below Hi, the temperature of the drying chamber 1 is stabilised S54, and is maintained for a selected period of time D, even if the setpoint temperature T3 is not reached.

By way of a non-limiting example, the duration D is 2 hours.

Advantageously, stabilisation of the temperature for a selected period D when the measured humidity reaches a value within a selected range of target humidity values allows hygroscopic rebalancing of the wood to be dried.

In a cooling stage under CO₂ S6, the temperature in the drying chamber 1 is reduced according to selected conditions.

In practice, the temperature reduction stage in a second phase S6 comprises a sub-stage of deactivation S61 of the flow reversal module and the means of recycling 600.

By way of a non-limiting example, the chosen temperature gradient G3 is 2° C./hour.

In practice, the temperature gradient G3 is chosen to be identical, regardless the specific drying profile of the wood to be dried, as well as dynamically, so as to be adjusted as the chosen final target value Hc for wood humidity is approached.

By way of a non-limiting example, the final target value Hc is between 0% and 18%.

The process according to the invention furthermore comprises a stage of discharge S7 of the atmosphere from the drying chamber, including the CO₂, configured to desaturate the drying chamber in CO₂ and thus extract the dried wood when the measured humidity of the wood is less than or equal to the final target value Hc, and after stabilisation of the temperature for the selected period.

All the stages of the process are controlled and carried out via a succession of fully automated commands by the computerised control system 6, which includes the application programming interface (API). As the API executes a control program, it sends various instructions to each of the control components and receives the recording data from the metrological means 5 of the drying installation in real time from the start to the end of the process, which enable adjustment of the control components in order to optimise drying in the event of any deviation from the setpoint values.

The drying profile is specific to each type of wood, with each type of wood therefore having a hygrometric evolution curve at the heart of the wood as a function of its particular drying time and the associated specific temperature increase sequences, which dictate the temperature increase profile to be applied during the heating phases, and serves as a basis for comparison with the metrological measurements recorded so that the computerised control system 6 retrospectively readjusts these same measurements back to the setpoint values, in order to obtain optimum industrial drying of the wood.

In practice, the temperature gradients G1, G2, G3 are varied by the computerised control system 6, so as to control changes in humidity in the heartwood of the wood during drying.

In practice, as the humidity in the wood to be dried varies, the ambient humidity, average humidity, minimum humidity and maximum humidity are monitored by metrological means 5.

By recording control of the setpoint values associated with the measurements observed, it is possible to establish a hygrometric drying profile specific to the species of wood to be treated and thus define the retrospective adjustments by the computerised control system 6 for wood of the same species during subsequent drying operations, and thus industrialise drying while preserving the macromolecular structure of the dried wood with the substitution of bound water by CO₂.

In addition, each transition from one stage to another is dependent only on the humidity target that applies to the current stage and not on whether or not the setpoint temperature of the current stage is achieved.

The process described above furthermore makes it possible to obtain dried wood, also known as dried cellulosic material.

Advantageously, the dried lignocellulosic material exhibits little warping during drying under CO₂ and is dimensionally stable in the dried state.

Variations in water content in the cell walls normally lead to warping of the wood. Wood “swells” when it absorbs water, and contracts when it loses water. These dimensional variations in a sample of wood, causing a variation in volume, are not the same in the three reference directions: radial, tangential and longitudinal.

The dried cellulosic material has a tangential shrinkage of less than 5% and a radial shrinkage of less than 4%.

Furthermore, the dried lignocellulosic material exhibits less swelling when humidity is reabsorbed (rehumidification); indeed, swelling of the material is 50% less than that observed with conventional drying.

Advantageously, low tangential and radial shrinkage enables savings in material of up to 20% when the lignocellulosic material is used.

By way of a non-limiting example, the use of lignocellulosic material according to the invention in the manufacture of floor coverings makes it possible to reduce dimensional variations when the said floor coverings are exposed to variations in humidity.

Advantageously, the use of lignocellulosic material of the dried wood type makes it possible to obtain products with improved mechanical properties, with less swelling following reabsorption of humidity and improved durability, while limiting material losses during manufacture linked to warping, delamination and cracks, resulting in a yield of between 40 and 50% when the wood is processed using conventional drying. In other words, 50 to 60% less waste is obtained per cubic metre of wood processed.

The instrumentation and control, which are based on metrological measurements of the internal environment of the drying chamber 1 and of the wood, make it possible to avoid damaging the wood during drying, whereas all drying leads to unavoidable material shrinkage. This shrinkage is minimised by drying in a CO₂-saturated atmosphere. In the event of poor control, the structural quality of the dried wood thus obtained can therefore be significantly affected.

Cracks and sagging of the wood may appear as a result of poor control, thereby compromising the structural integrity of the dried wood obtained by the process according to the invention, thus generating a product not in accordance with the invention.

The process according to the invention therefore makes it possible, by fine adjustment of the humidity of the wood, to obtain dried wood of precise humidity, with a shrinkage of less than or equal to 5%, a negligible rate of warping, and with a limitation, or even elimination, of the onset of cracks in the wood thus dried.

In addition, any examples of means used are only specific illustrations of means that can be used for embodiment of the invention. The Person skilled in the art will understand that these examples are not limitative and are not restricted to the examples mentioned, but extend to any example of means, the implementation of which yields the same technical effect.

What is claimed is:

1. System for the thermal drying of wood by CO2 sequestration, having at least one CO2 atmosphere drying module comprising:
a drying chamber comprising at least one hollow cylindrical or virtually cylindrical drying tube of a diameter and length suitable for drying wood of selected dimensions,
means of supply of CO2 for injecting gaseous CO2 into the drying chamber,
means of heating for heating the circulating CO2;
means of gas circulation for forcing the circulation of CO2 from one end of the drying chamber to the other in a closed circuit in the direction of the length of the chamber, with injection and extraction positioned at the ends of the drying chamber, and for renewing the atmosphere inside the drying chamber;
means of recycling the CO2 configured to allow the separation of water vapour and gaseous CO2 present in the atmosphere extracted from the chamber during drying;
metrological means for measuring variations in the physical measurements of the drying module during heating;
means of supply of CO2; and,
a computerised control system for controlling the means of supply of CO2, the means of circulation, the means of heating, and the means of recycling, according to programmes, setpoint values and drying times appropriate to the quality of the dried wood required, and means of processing for measuring, comparing and readjusting the operating parameters to the setpoint values in the event of deviations, the drying module being characterised in that the means of gas circulation comprise a flow reversal module configured to allow the circulation of CO2 in a first direction of circulation in the drying chamber between an inlet duct connecting the means of heating to the drying chamber, configured to control the injection of the CO2 gas mixture into the drying chamber and an outlet duct connecting an outlet end of the drying chamber to said means of heating, forming a closed-loop circulation duct for the CO2 gas mixture, and in a second direction of circulation opposite to the first direction, capable of rendering uniform the thermal distribution in said drying chamber.

2. The system according to claim 1, wherein the inlet duct comprises a solenoid valve configured to control the injection of the CO2 gas mixture into the drying chamber, as well as means of gas circulation comprising at least one fan capable of operating bilaterally in two directions of circulation of the gas mixture, i.e. towards the drying chamber, and from the drying chamber, and in that the outlet duct comprises a solenoid valve configured to control the discharge of the CO2 gas mixture into the drying chamber, means of gas circulation comprising at least one fan capable of operating bilaterally in two directions of circulation of the gas mixture, towards the drying chamber, and from the drying chamber, the gas circulation means being configured to operate simultaneously in the same direction of circulation.

3. The system according to claim 1, wherein the inlet duct comprises a solenoid valve configured to control the injection of the CO2 gas mixture into the drying chamber, said inlet duct comprising at least two ducts connected to the drying chamber, each duct comprising at least one fan, each fan being configured to operate in one direction of circulation, at least one fan towards the drying chamber and one fan from the drying chamber in the inlet duct, and in that the outlet duct comprises at least two ducts connected to the drying chamber, each duct comprising at least one fan being configured to operate in one direction of circulation, at least one fan towards the drying chamber and one fan from the drying chamber to the means of heating.

4. The system according to claim 1, wherein the outlet duct also comprises metrological means configured to measure parameters belonging to the group formed by the flow rate of the injected circulating CO2 gas mixture, the temperature of the injected circulating CO2 gas mixture and the humidity of the circulating gas mixture.

5. The system according to claim 1, wherein the means of recycling of the CO2 comprise a heat exchanger-type system configured to cool the circulating gas mixture in order to cause condensation of the water in said mixture and enable extraction of said condensed water, and configured to reheat the cooled gas mixture following extraction of the water to a temperature differential of 50° ° C. with the temperature of the circulating gas mixture, for re-injection into the drying chamber.

6. The system according to claim 5, wherein the means of recycling of the CO2 are of the heat exchanger type comprising at least one cold battery, configured to gradually extract water from the gas mixture, each cold battery being capable of extracting a chosen percentage of water from said gas mixture.

7. The system according to claim 6, wherein the heat exchanger of the means of recycling of the CO2 is only active during the drying phase, and when the measured humidity of the circulating gas mixture is between a maximum threshold value and a minimum threshold value.

8. The system according to claim 1, wherein the means of supply of CO2 belong to the group formed by a system for injecting CO2 from CO2 in a pressurised cylinder, a CO2 supply discharged from a methanisation plant, a CO2 supply of the industrial chimney type, and an installation for wood drying by attached CO2 sequestration, or a combination thereof.

9. The system according to claim 1, wherein the computerised control system is equipped with an application programming interface configured to:
Acquire metrological data and parameters of the wood to be dried by measuring the metrological means;
Activate the means of supply of CO2 configured to saturate the drying chamber with CO2;
Verify that the CO2 saturation in the circulating gas mixture is sufficient to initiate a drying cycle by checking the means of measurement of CO2/CH4 in the discharge duct;
Activate the means of heating to adjust the humidity of the wood by heating when a sufficient measured CO2 saturation is achieved.
If the humidity of the wood exceeds 30%, heating with a temperature limit according to a first setpoint temperature T1, according to a selected temperature gradient G1 in order to extract the free water from the wood to be dried and activating the means of circulation;
If the humidity of the wood is less 30%, heating with a temperature limit according to a first setpoint temperature T2, according to a selected temperature gradient G2 in order to extract the bound water from the wood to be dried and activating the means of circulation;
stabilise the temperature of the CO2 circulating in the drying chamber in a first phase when a humidity of less than or equal to 30% is measured, activate the means of recycling and subsequently increase the temperature of the CO2 circulating in the drying chamber in a second phase until the measured humidity of the wood reaches a chosen intermediate target value Hi, the means of heating being activated so that reheating is carried out with a limit temperature defined by a second setpoint temperature T2 of 120° C. according to a selected temperature gradient G2, and as a function of the specific drying profile of the wood to be dried enabling the bound water to be extracted from the wood to be dried;
Deactivate the means of recycling and vary the activity of the means of heating to reduce the temperature of the heating chamber in a first phase, down to a third stabilisation setpoint temperature T3 chosen according to a temperature gradient G3, when the average humidity of the wood measured via the means for measurement of the humidity of the wood reaches the chosen intermediate target value Hi, unless one of the measured humidity values of the wood is greater than Hi+A %, A being a selected value, said setpoint temperature T3 being maintained for a selected period of time until the measured humidity value of the wood greater than Hi+A % is stable and within a range of values less than Hi+A %;
Deactivate the means of heating, in order to reduce the temperature of the heating chamber in a second phase, when the measured average humidity of the wood reaches the final target humidity value Hc.
